(19) United States
(12) Patent Application Publication
(10) Pub. No.: US 2014/0325352 A1
(43) Pub. Date: Oct. 30, 2014

(54) MANAGEMENT OF CONTEXT-SENSITIVE HELP LINKS

(71) Applicants: Rory Kleeman, Narooma (AU); Stefan G.E Tober, Ocean Shores (AU)

(72) Inventors: Rory Kleeman, Narooma (AU); Stefan G.E Tober, Ocean Shores (AU)

(21) Appl. No.: 14/359,473

(22) PCT Filed: Nov. 21, 2011
(86) PCT No.: PCT/US2011/061722

§ 371 Date: May 20, 2014

(51) Int. Cl. G06F 3/0481

(52) U.S. Cl. CPC G06F 3/0481
USPC 715/708

(57) ABSTRACT

Systems, methods, and computer-readable and executable instructions are provided for management of context-sensitive help (CSH) links. Management of CSH links can include assigning a unique identifier to a CSH link in a program that links to a help system. Management of CSH links can include identifying a user interface resource that calls the help system for the CSH link and mapping the user interface resource for the CSH link to an anchor point in the help system. Management of the CSH links can include generating a reference between the unique identifier of the CSH link and the anchor point in the help system.

### BACKGROUND

Some computer programs provide an increasing and complex number of options and functions available to a user. Programs can be accompanied by a set of separate reference material, such as a help system in the form of one or a set of help files. The help system can offer explanations for various options and functions associated with the program at a level of depth that is beyond the normal presentation attributes of the program. For example, the help system can attempt to answer common questions that users of the program may have during operation of the program. The help system is typically provided by the same source as the program.

### BRIEF DESCRIPTION OF THE DRAWINGS

FIG. 1 is a flow chart illustrating an example of a method for management of context-sensitive help (CSH) links according to the present disclosure.

FIG. 2A illustrates a block diagram of an example of a process for management of CSH links according to the present disclosure.

FIG. 2B illustrates a block diagram of an example of a user interface resource that can call a CSH link according to the present disclosure.

FIG. 3 illustrates a block diagram of an example of a computer-readable medium in communication with processing resources for management of CSH links according to the present disclosure.

### DETAILED DESCRIPTION

Examples of the present disclosure may include methods, systems, and computer-readable and executable instructions and/or logic. An example of a method for management of context-sensitive help (CSH) links may include assigning a unique identifier to a CSH link in a program that links to a help system. An example of a method for management of CSH links may include identifying a user interface resource that calls the help system for the CSH link and mapping the user interface resource for the CSH link to an anchor point in the help system. An example of a method for management of CSH links may include generating a reference between the unique identifier of the CSH link and the anchor point in the help system.

Many computer programs are accompanied by a set of separate reference material designed to explain how the program works at a level of depth that is beyond the normal presentation attributes of the program. Such reference material is generally referred to as a help system which can be in the form of one or a set of help files. Some programs may provide a screen or window-based user interface. Programs with a window-based user interface may allow a user to directly access the help system from the program, where the user is linked to the section of the help system that is most relevant to the activity that the user is currently undertaking within the program. These direct links to the relevant section of the help system may generally be referred to as context-sensitive help links.

In many cases, the help system is prepared by a different team or group of people than those responsible for the development of the program. As the program is developed over time, the help system may be updated to reflect the changes in the program. If the context-sensitive help links are not updated along with the program, the links may become inoperable or broken. For example, when a new function or module of the program is developed, a new context-sensitive help link may be added that links to an appropriate section of the help system. Or, when a function or module of the program is deleted by the developers, the corresponding content in the help system may be deleted. However, because the help system and program are developed by different teams or people, inoperable context-sensitive help links may remain in the program, or conversely, the content relevant to the removed functionality may remain in the help system.

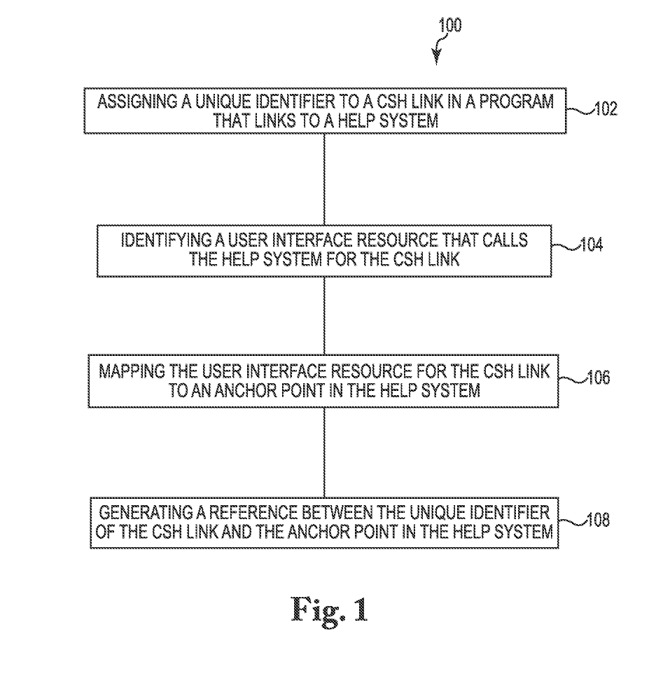

FIG. 1 is a flow chart illustrating an example of a method for management of context-sensitive help (CSH) links according to the present disclosure. The method 100 can be used to help ensure that a program will use valid CSH links that link to a help system.

At 102, a unique identifier can be assigned to CSH link in a program that links to a help system. A CSH link can be found in a program that links to a help system. A program can include a newly created program or an updated version of an existing program. A CSH link can include a direct link from a program to an anchor point in a help system. A help system can include one or a set of help files to explain how functions of the program work at a level that is beyond the normal presentation attributes of the program. A unique identifier can include a unique moniker that can be used by both the program and the help system when referencing a CSH. For example, a unique identifier can include a 32-bit number, or any other appropriate identifier. The unique moniker can be independent of the executable instructions of both the program and the help system.

In various examples of the present disclosure the unique identifier can include a unique moniker, a CSH link name, and a CSH link type. The unique moniker can be used for generating a reference to the anchor point in the help system, as discussed in the present disclosure. The CSH link name can include a human-readable name. The CSH link name can make it easier for a programmer to read the CSH link when discrepancies are to be reported. The CSH link type can include characteristics of the program context of the user interface resources that can call the help system for the CSH link, as discussed in the present disclosure. Examples of CSH link types include a window or screen within the program, a user-interface control that appears on a window or screen, and a command that appears on a menu within a program, among many others.

At 104, a user interface resource can be identified that calls the help system for the CSH link. A user interface resource can include a location in the executable instructions or a function in the executable program that can call the CSH link. An example user interface resource can include a dialogue box for archiving a file. For example, when a consumer of the program attempts to archive a file, a dialogue box may prompt the consumer to confirm archiving the file. The dialogue box may include a link, for example “what is archive?”, which when selected by the consumer links the user to the help system context that explains archiving a file. A call to the help system for the CSH link can include attempting to use the executable instructions or the particular function in the program.

At 106, the identified user interface resource for the CSH link can be mapped to an anchor point in the help system. An anchor point in the help system can be a specific section of the help system, which can include specific sections of executable instructions. Examples of anchor points in the help system include a topic of the program in the help system, a relevant activity of the program in the help system, and a description of a specific function of the program in the help system, among many others. In some examples of the present disclosure, the context of the anchor point may not yet exist because a complete help system has not been created. Accordingly, the anchor point may include an identification of a future anchor point. For example, the identification of a future anchor point can include a place holder that indicates a specific section of the future help system will exist and flags the specific section for future reference.

At 108, a reference can be generated between the unique identifier of the CSH link and the anchor point in the help system. The reference generated between the unique identifier of the CSH link and the anchor point in the help system can be used to help ensure that the CSH link is operable. For example, a CSH link that does not have a generated reference between the program and the anchor point in the help system can be automatically flagged as inoperable.

In various examples of the present disclosure, the method can include assigning a unique identifier to existing CSH links in a program that links to the help system. For example, each existing CSH link can be assigned a unique identifier. The unique identifier of existing CSH links can be stored in a registration table in a memory. Various examples of the present disclosure can include identifying a user interface resource that calls the help system for the existing CSH links and mapping the user interface resource for the existing CSH links to an anchor point in the help system. For example, a user interface resource can be identified for each existing CSH link and the user interface resource for each existing CSH link can be mapped to an anchor point in the help system. The identification of the user interface resource for the existing CSH links can be stored in a header file in a memory. A header can be an include file, or another appropriate type of file. Further, a reference can be generated between the unique identifier of the CSH links and the anchor point in the help system. For example, a reference can be generated between the unique identifier of each of the CSH links and the anchor points in the help system of each of the CSH links. The references can be stored in an enumeration definition file in a memory. Enumeration definition files can define each anchor point in the help system to a class and provide a function which incorporates the unique identifier. An example of a function is:

LinkToHelp(CSL_moniker).

In various examples of the present disclosure, the method can include analyzing the program for CSH links with a unique identifier that are referenced in the help system and flagging CSH links having a unique identifier that is unreferenced in the program as inoperable. The analyzing and flagging can be used to verify that all CSH links in the program are operable. A CSH link which is unreferenced in the program may be inoperable. Inoperable CSH links can include a CSH link which does not properly link to an anchor point in the help system. For example, if a function is deleted from the program then the CSH link may be obsolete. In various examples of the present disclosure, inoperable CSH links can be automatically removed from the program and/or a notification can be sent to a user or an administrator of the help system. An administrator of the help system can include a person or group of people responsible for developing the help system.

In some examples of the present disclosure, the method can include identifying the user interface resource that can call the help system for the CSH link using a help system authoring tool. A help system authoring tool can include a program, such as FLARE. The help system authoring tool can assign a topic for the anchor point that is mapped to the user interface resource and generate the help system. The generated help system can be an updated help system, for example. The help system can include help system context for each assigned topic in the respective anchor point and can use the unique identifier to refer to a CSH link. For example, help system context may include executable instructions that may explain the assigned topic. Using the help system authoring tool may identify an initial amount of obsolete content in the help system. Obsolete content in the help system can include executable instructions, such as content in the help system that relates to a function that may have been removed from the program.

In some examples of the present disclosure, the method can include importing identifications of the user interface resources that can call the help system for existing CSH links with a help system authoring tool. In some examples of the present disclosure, the identifications of all the user interface resources may be in a header file. The help system authoring tool can import the header file identifying all the user interface resources to generate an alias file. The alias file can use the header file and can add further data that corresponds to the user interface resource identified in the header file. Using the help system authoring tool, a topic can be assigned to an anchor point in the help system that is mapped to a respective user interface. The help system authoring tool can use the alias file to generate a help system. The generated help system can include an updated help system, for example.

The method can include analyzing the help system for CSH links with a unique identifier referenced in the program and automatically flagging the CSH links having a unique identifier that is unreferenced in the help system as inoperable. The analyzing and flagging can be used to verify that all CSH links to the help system are operable. An inoperable CSH link to the help system can include a function in the program with a CSH link that is missing help system context in the anchor point. Missing help system context in the anchor point can render the link invalid as the anchor point has no corresponding topic assigned. In various examples of the present disclosure, a notification can be sent to a user or an administrator of the help system in response to flagging inoperable CSH links.

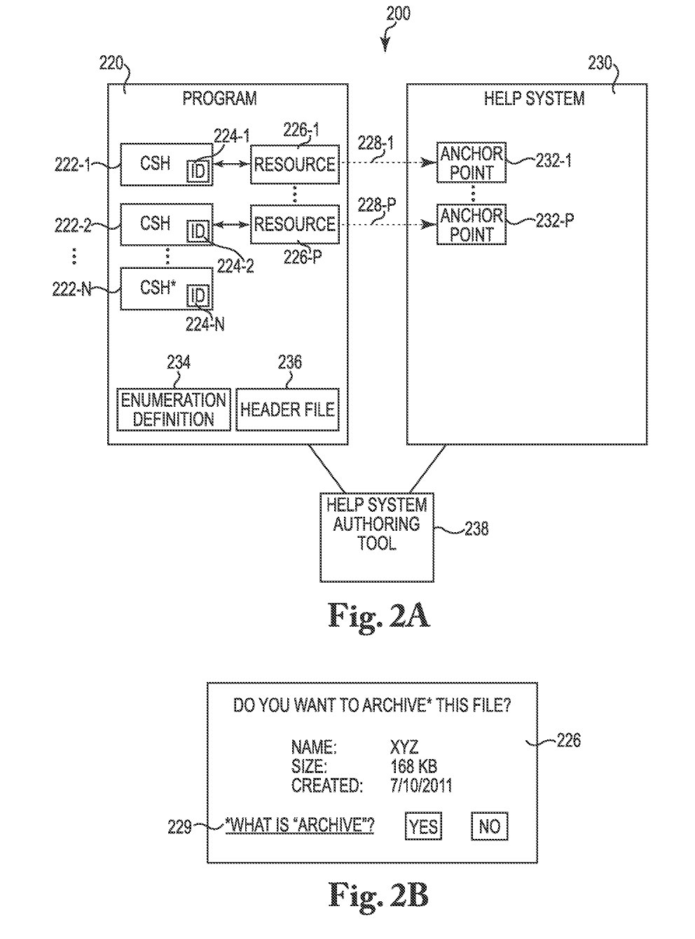

FIG. 2A illustrates a block diagram of an example of a process 200 for management of CSH links 222-1, 222-2 . . . 222-N according to the present disclosure. The process 200 can include a program 220 and a corresponding help system 230 with CSH links 222-1, 222-2 . . . 222-N. A CSH link 222-1, 222-2 . . . 222-N can be identified in a program 220 that links 228-1 . . . 228-P to a help system 230. Identification of a CSH link can include locating, identifying, and finding, among others. The CSH link 222-1, 222-2 . . . 222-N can be registered with a unique identifier 224-1, 224-2 . . . 224-N in a registration table. The unique identifier 224-1, 224-2 . . . 224-N can be independent of the executable instructions of both the program 220 and the help system 230. The registration table can be stored in a memory using a parser tool or any other appropriate mechanism.

A header file 236 can be generated identifying a user interface resource 226-1 . . . 226-P that can call the help system 230 for the CSH link 222-1, 222-2 . . . 222-N. The user interface resource 226-1 . . . 226-P can be mapped to an anchor point 232-1 . . . 232-P in the help system 230. An enumeration definition file 234 can be generated that comprises a reference between the unique identifier 224-1, 224-2 . . . 224-N and the anchor point 232-1 . . . 232-P in the help system 230. A CSH link 222-N in the program 220 that does not have a generated header file 236 or enumeration definition file 234 can be automatically flagged as inoperable in the registration table. A CSH link 222-N that does not have a generated header file 236 or enumeration definition file 234 may not have a corresponding anchor point 232-1 . . . 232-P in the help system 230, which can render the CSH link 222-N inoperable or broken. Accordingly, the reference generated between the unique identifier 224-1, 224-2 . . . 224-N and the anchor point 232-1 . . . 232-P in the help system 230 can be used to help ensure that the CSH link 222-1, 222-2 . . . 222-N is operable.

A help system authoring tool 238 can import the header file 236 identifying a user interface resource 226-1 . . . 226-P to generate an alias file. An alias file can include the identification of the user interface resource 226-1 . . . 226-P and additional data which corresponds to a CSH link 222-1,222-2 . . . 222-N. The additional data may include a topic for each anchor point 232-1 . . . 232-P that is mapped to the user interface resource 226-2 . . . 226-P, among many others. A topic can be assigned to the user interface resource 226-1 . . . 226-P. A topic of the user interface resource 226-1 . . . 226-P can correspond to the anchor point 232-1 . . . 232-P of the respective user interface resource 226-1 . . . 226-P. The help system authoring tool 238 can use the alias file, including the topics corresponding to the anchor points 232-1 . . . 232-P to create the updated help system 230.

In various examples of the present disclosure, the process 200 can include analyzing the executable instructions of the program 220 and the updated help system 230 for registered CSH links 222-1, 222-2 . . . 222-N that are not mutually referenced. A CSH link 222-1, 222-2 . . . 222-N that is registered in the registration table may be referenced in the executable instructions of both the program 220 and the help system 230. If a CSH link 222-1, 222-2 . . . 222-N is not mutually referenced in the program 220 and the help system 230, the CSH link 222-1, 222-2 . . . 222-N can be automatically flagged as inoperable in the registration table. A notification can be sent in response to a flagged inoperable CSH link 222-N in the reference table. Flagging can include indicating the CSH link 222-N as inoperable. An inoperable CSH link 222-N can include obsolete help guide context or a broken CSH link. In some examples of the present disclosure, the analyzing and flagging of the unreferenced CSH link 222-N can be automatically repeated at a predetermined time period. A predetermined time period can include nightly, weekly, or hourly, among many others.

In various examples of the present disclosure, the user interface resource 226-1 . . . 226-P can be mapped to the help system anchor point 232-1 . . . 232-P in the header file 236. The identification for the user interface resource 226-1 . . . 226-P can be identical to the identification of the respective help system anchor point 232-1 . . . 232-P and, therefore, mapping from the user interface resource 226-1 . . . 226-P to the anchor point 232-1 . . . 232-P may not be separately required. Accordingly, mapping the user interface resource 226-1 . . . 226-P to the CSH link 221-1, 222-2 . . . 222-N anchor point 232-1 . . . 232-P can be performed in the header file 236.

In various examples of the present disclosure, the process 200 can include prompting a first user to update the header file 236 when a CSH link 222-1, 222-2 . . . 222-N or a user interface resource 226-1 . . . 226-P is changed. A first user can include a user of the program 220. A user of the program 220 can include a person or group of people developing the program 220. A change to the CSH link 222-1, 222-2 . . . 222-N or a user interface resource 226-1 . . . 226-P can include removing, modifying, or adding a new CSH link or user interface resource, among many others. For example, the prompting can include a dialogue box requesting the user of the program 220 to change the header file 236 and may include a denial to save the change to the CSH link 222-1, 222-2 . . . 222-N or user interface resource 226-1 . . . 226-P until the header file 236 is updated, among many other prompts. A notification can be automatically sent to a second user when the header file 236 is changed. A second user can include a help system 230 administrator. An administrator of the help system 230 can include a person or group of people developing the help system 230.

FIG. 2B illustrates a block diagram of an example of a user interface resource 226 that can call 229 a CSH link according to the present disclosure. A user interface resource 226 can include a location in the executable instructions or a function in the executable program that can call 229 the CSH link. For example, a user interface resource 226 can include a dialogue box for archiving a file. A call 229 to the help system can include attempting to use the executable instructions or the particular function in the program. For example, a call 229 to the help system can include attempting to use the executable instructions to link to the help system when a user selects the call “What is ‘archive’?” 229 within the user interface resource 226.

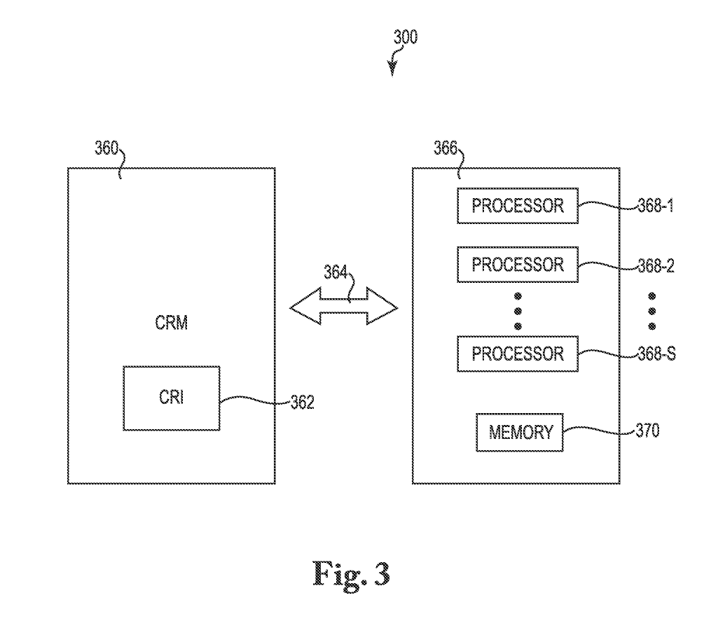

FIG. 3 illustrates a block diagram of an example of a computer-readable medium (CRM) 360 in communication with processing resources 368-1, 368-2 . . . 368-S for management of CSH links according to the present disclosure. CRM 360 can be in communication with computing resources 366 (e.g., a number of computing devices, such as servers having processor resources of more or fewer than 368-1, 368-2 . . . 368-S). The computing resources 366 can be in communication with, and/or receive a tangible non-transitory CRM 360 storing a set of computer-readable instructions 362 executable by one or more of the processor resources 368-1, 368-2 . . . 368-S, as described herein. The computing resources 366 may include memory resources 370, and the processor resources 368-1, 368-2 . . . 368-S may be coupled to the memory resources 370.

Processor resources 368-1, 368-2 . . . 368-S can execute computer-readable instructions 362 that are stored on an internal or external non-transitory CRM 360. A non-transitory CRM (e.g., CRM 360), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of computer-readable media.

The non-transitory CRM 360 can be integral, or communicatively coupled, to a number of computing devices, in either in a wired or wireless manner. For example, the non-transitory computer-readable medium can be an internal memory, a portable memory, a portable disk, or a memory associated with another computing resource (e.g., enabling the computer-readable instructions to be transferred and/or executed across a network such as the Internet).

The CRM 360 can be in communication with the processor resources 368-1, 368-2 . . . 368-S via a communication path 364. The communication path 364 can be local or remote to a machine associated with the processor resources 368-1, 368-2 . . . 368-S. Examples of a local communication path 364 can include an electronic bus internal to a machine such as a computer where the CRM 360 is one of volatile, non-volatile, fixed, and/or removable storage medium in communication with the processor resources 368-1, 368-2 . . . 368-S via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 364 can be such that the CRM 360 is remote from the processor resources (e.g., 368-1, 368-2 . . . 368-S) such as in the example of a network connection between the CRM 360 and the processor resources (e.g., 368-1, 368-2 . . . 368-S). That is, the communication path 364 can be a network connection. Examples of such a network connection can include a local area network (LAN), a wide area network (WAN), a personal area network (PAN), and the Internet, among others. In such examples, the CRM 360 may be associated with a first computing device and the processor resources 368-1, 368-2 . . . 368-S may be associated with a second computing device (e.g., a server).

The processor resources 368-1, 368-2 . . . 368-S coupled to the memory resources 370 can register a new CSH link with a unique identifier in a registration table, where the registration table includes a plurality of existing registered CSH links that link from a program to a respective help system anchor point. The unique identifier can be independent of the executable instructions of both the program and the help system. For example, a unique identifier can be assigned to each of the plurality of existing registered CSH links. The processor resources 368-1, 368-2 . . . 368-S coupled to the memory resources 370 can update a header file identifying a user interface resource for the plurality of registered CSH links that calls the respective help system anchor point to include a identified user interface resource for the new CSH link. For example, a user interface resource can be identified for each of the plurality of existing registered CSH links. The processor resources 368-1, 368-2 . . . 368-S coupled to the memory resources 370 can update a enumeration definition file comprising a reference between the unique identifier of the plurality of CSH links and the respective help system anchor point to include a reference for the CSH link; where, the identification for the user interface resource is identical to the identification of the respective help system anchor point and, therefore, mapping from the user interface resource to the respective anchor point may not be required. For example, each existing registered CSH link may have a reference to a respective help system anchor point. The reference generated in the enumeration definition file between the unique identifier of the CSH link and the respective anchor point in the help system can be used to help ensure that the CSL is operable

The processor resources 368-1, 368-2 . . . 368-S coupled to the memory resources 370 can prompt a first user to update the header file when a CSH link or user interface is changed. A change to a CSH link or user interface resource can include adding executable instructions, deleting executable instructions, or modifying executable instructions, among others. The processor resources 368-1, 368-2 . . . 368-S coupled to the memory resources 370 can automatically send a notification to a second user in response to an updated header file.

In various examples of the present disclosure, the processor resources 368-1, 368-2 . . . 368-S coupled to the memory resources 370 can identify a CSH link registered in the registration table that is not mutually referenced in the program and the help system and indicate the registered CSH link that is not mutually referenced as inoperable in the registration table. The processor resources 368-1, 368-2 . . . 368-S coupled to the memory resources 370 can notify a user or a help system administrator of inoperable CSH links in the registration table. In various examples of the present disclosure, the processor resources 368-1, 368-2 . . . 368-S coupled to the memory resources 370 can automatically remove the inoperable CSH links from the program and help system.

In various examples of the present disclosure, the processor resources 368-1, 368-2 . . . 368-S coupled to the memory resources 370 can map the user interface resource to the help system anchor point. Mapping the user interface resource to the help system anchor point may be necessary when the identification of the user interface resource is not identical to the identification of the help system anchor point.

The above specification, examples, and data provide a description of the method and applications, and use of the system and method of the present disclosure. Since many examples can be made without departing from the spirit and scope of the system and method of the present disclosure, this specification merely sets forth some of the many possible embodiment configurations and implementation.

What is claimed:

1. A method for management of context-sensitive help (CSH) links, comprising:
assigning a unique identifier to a CSH link in a program that links to a help system;
identifying a user interface resource that calls the help system for the CSH link;
mapping the user interface resource for the CSH link to an anchor point in the help system; and
generating a reference between the unique identifier of the CSH link and the anchor point in the help system.

2. The method of claim 1, wherein the unique identifier of the CSH link includes a unique CSH moniker for generating the reference to the anchor point in the help system, a CSH name that comprises a human-readable name, and a CSH type that identifies characteristics of a program context for the user interface resource.

3. The method of claim 1, further comprising using a help system authoring tool to:
identify the user interface resource that calls the help system for the CSH link;
assign a topic for the anchor point that is mapped to the user interface; and
generate an updated help system.

4. The method of claim 1, further comprising:
assigning a unique identifier to existing CSH links in a program that links to the help system;
identifying for the existing CSH links, a user interface resource that calls the help system;
mapping the user interface resource for the existing CSH links to an anchor point in the help system; and
generating a reference between the unique identifier of the CSH links and the anchor point in the help system.

5. The method of claim 4, further comprising:
analyzing the program for CSH links with unique identifiers that are referenced in the help system; and
flagging CSH links having a unique identifier that is unreferenced in the program as inoperable.

6. The method of claim 4, further comprising:
importing identifications of the user interface resources that call the help system for the existing CSH links;
assigning a topic for the existing anchor points that is mapped to a respective user interface;
generating the help system including each existing CSH link;
analyzing the help system for CSH links with a unique identifier that are referenced in the program; and
flagging CSH links having a unique identifier that is unreferenced in the help system as inoperable.

7. A non-transitory computer-readable medium storing a set of instructions executable by a processor to cause a computing device to:
identify a context-sensitive help (CSH) link in a program that links to a help system;
register the CSH link with a unique identifier in a registration table;
generate a header file identifying a user interface resource that calls the help system for the CSH link;
map the user interface resource to an anchor point in the help system;
generate an enumeration definition file comprising a reference between the unique identifier of the CSH link and the anchor point in the help system;
use a help system authoring tool to:
import the header file identifying a user interface resource to generate an alias file;
assign a topic for the anchor point that is mapped to the user interface resource in the alias file; and
generate an updated help system.

8. The non-transitory computer-readable medium of claim 7, wherein the instructions are executable to:
prompt a first user to update the header file when a CSH link or user interface resource is removed, changed, or added; and
automatically send notification to a second user when the header file is updated.

9. The non-transitory computer-readable medium of claim 7, wherein the instructions are executable to:
analyze the program and the help system for registered CSH links that are not mutually referenced;
indicate the CSH links that are not mutually referenced as inoperable in the registration table; and
send notification of inoperable CSH links in the registration table.

10. The non-transitory computer-readable medium of claim 9 wherein the instructions are executable to automatically repeat the analyze and indication of the CSH links that are not mutually referenced at a predetermined time period.

11. The non-transitory computer-readable medium of claim 7, wherein the instructions are executable to build the registration table in memory using a parser.

12. A system for managing context-sensitive help (CSH) links comprising:
a processor;
a memory coupled to the processor, the memory storing instructions that, when executed, cause the processor to:
register a new CSH link with a unique identifier in a registration table, wherein the registration table includes a plurality of existing registered CSH links in a program that link to a respective help system anchor point;
update a header file identifying, for the plurality of existing registered CSH links, a user interface resource that calls the respective help system anchor point to include a identified user interface resource for the new CSH link;
update an enumeration definition file comprising a reference between the unique identifier of the plurality of existing registered CSH links and the respective help system anchor point to include a reference for the new CSH link;
in response to a CSH link or user interface resource changing, prompt a first user to update the header file; and
automatically send notification to a second user when the header file is updated.

13. The system of claim 12, wherein the memory further stores instructions that cause the processor to:
identify a CSH link registered in the registration table that is not mutually referenced in the program and the help system; and
indicate the registered CSH link that is not mutually referenced as inoperable in the registration table.

14. The system of claim 12, wherein the memory further stores instructions that cause the processor to remove the inoperable CSH links from the program and the help system.

15. The system of claim 12, wherein the memory further stores instructions that cause the processor to map the user interface resource to the help system anchor point.
